(19) United States
(12) Patent Application Publication
(10) Pub. No.: US 2026/0032448 A1
(43) Pub. Date: Jan. 29, 2026

(54) Methods for Trust Index Aware Repository Functions and Systems Thereof

(71) Applicant: InterDigital Patent Holdings, Inc., Wilmington, DE (US)

(72) Inventors: Chonggang Wang, Princeton, NJ (US); Xu Li, Plainsboro, NJ (US); Robert Gazda, Spring City, PA (US); Michael Starsinic, Newtown, PA (US); Samir Ferdi, Kirkland (CA); Ulises Olvera-Hernandez, Saint-Lazare (CA)

(73) Assignee: InterDigital Patent Holdings, Inc., Wilmington, DE (US)

(21) Appl. No.: 18/781,229

(22) Filed: Jul. 23, 2024

(51) Int. Cl. H04W 12/60; H04W 12/062

(52) U.S. Cl. CPC H04W 12/66; H04W 12/062

(57) ABSTRACT

Various embodiments provide one or more methods for trust index aware repository functions (TIARFs) and systems thereof. A TIARF may reside in a core network (CN), an edge network, a radio access network, a local network, an enhanced network repository function in the CN, a wireless transmit/receive unit, a service enabler server, an edge application server, an application function, and/or a server in a data network. The TIARF provides mutual trust between one or more function entity service consumers (FESCs) and function entity service producer (FESPs). The TIARF utilizes one or more trust indexes associated with the one or more FESCs and/or FESPs, and matches the one or more FESPs and FESCs based on the one or more trust indexes. The TIARF utilizes a trust management function to determine the one or more trust indexes, and stores one or more FESP profiles associated with one or more registered FESPs.

### BACKGROUND

Conventional fifth generation (5G) systems (5GS) face multiple limitations in supporting dynamic service access by a user because the conventional 5GS do not consider a trust between a service consumer and a service producer. First, the 5GS do not consider a dynamic user context and also do not sufficiently support dynamic user authentication. Second, the 5GS do not support dynamic user authentication based on a trust index of the user (e.g., the service consumer) or a trust index of the service producer. The conventional 5GS authenticate the user only once. After the initial authentication, the user can access multiple network services of different types and/or from different locations for a long time, even when the user context associated with the user changes. This poses security concerns and renders the 5GS more vulnerable to potential attacks. Therefore, there is a need for a secure wireless system that can securely maintain the trust between the service producers and the service consumers.

### SUMMARY

In an embodiment, a method for a function entity service producer (FESP) registration is provided. The method may be performed by a trust index aware repository function (TIARF). The method includes receiving, from an FESP, a registration request including a trust index container (TIC). The TIARF identifies a trust management function (TMF) based on the TIC. The TIARF transmits an authorization request to the TMF. The authorization request is indicative of registration of the FESP. The TIARF receives a trust index value associated with the FESP from the TMF. The TIARF compares the trust index value to a first trust index threshold. The TIARF transmits a registration response to the FESP. The registration response is indicative of registration of the FESP if the trust index value is greater than the first trust index threshold.

In an embodiment, the trust index value is indicative of at least one of: an instantaneous trust index value, or an average trust index value averaged over a trust index window.

In an embodiment, the trust index value includes of at least one of: a device trust index (DTI) value associated with the FESP, or a user trust index (UTI) value associated with a user of the FESP.

In an embodiment, the trust index value associated with the FESP indicates a level of trustworthiness of the FESP.

In an embodiment, the trust index value is based on an evaluation of one or more trust indicators related to at least one of: security, privacy, resilience, performance, robustness, scalability, availability, accuracy, reliability, reputation, or consistency.

In an embodiment, the TIARF generates an updated FESP profile associated with the FESP based on the trust index value. The TIARF stores the TIC and the updated FESP profile. The registration response includes the updated FESP profile.

In an embodiment, the TIARF marks the FESP as discoverable if the trust index value is greater than a second trust index threshold. The TIARF marks the FESP as non-discoverable if the trust index value is less than the second trust index threshold.

In an embodiment, the TIARF receives an updated trust index value associated with the FESP from the TMF. The TIARF compares the updated the trust index value to a third trust index threshold. The TIARF de-registers the FESP if the updated trust index value is less than the third trust index threshold. The TIARF deletes an FESP profile associated with the FESP upon deregistration of the FESP.

In an embodiment, for selecting the TMF, on a condition that the TIC includes a TMF identifier (TMFID), the TIARF identifies a TMF associated with the TMFID. The TIARF selects the identified TMF.

In an embodiment, for selecting the TMF, on a condition that the TIC does not include the TMFID, the TIARF determines at least one of a service type or a service name indicated by the TIC. The TIARF selects a TMF from a list of TMFs associated with at least one of the service type or the service name.

In an embodiment, the method is implemented by one or more of: a wireless transmit/receive unit (WTRU), a function in an edge network, a function in a radio access network, a function in a local network, a function in a non-public network, a function in a core network (CN), an enhanced network repository function (NRF) in the CN, and/or a server in a data network.

In another embodiment, a TIARF for an FESP discovery is provided. The TIARF receives, from a function entity service consumer (FESC), an FESP discovery request. FESP discovery request includes a FESC identifier (ID) and a trust index aware discovery filter (TIADF). The TIADF includes an FESP trust index threshold. The TIARF obtains an FESC trust index value associated with the FESC based on the FESC ID. The TIARF authorizes the FESP discovery request if the FESC trust index value is greater than an FESC trust index threshold. The TIARF determines a list of FESPs wherein each FESP of the list of FESPs is associated with an FESP trust index value greater than the FESP trust index threshold. The TIARF transmits, to the FESC, an FESP discovery response including the list of FESPs.

In an embodiment, the TIARF transmits, to a TMF, a request including the FESC ID. The TIARF receives, from the TMF, the FESC trust index value associated with the FESC.

In an embodiment, the TIADF further includes a notification timer. The TIARF receives, from the TMF, a first FESP trust index value associated with a first FESP. On a condition that the first FESP trust index value is greater than the FESP trust index threshold and the notification timer has not expired, the TIARF transmits a notification indicative of the first FESP to the FESC.

In an embodiment, a WTRU functioning as a FESC and/or a FESP is provided. The WTRU functioning as the FESC may include a memory, a processor, and a transceiver. The WTRU may transmit an FESP discovery request including a WTRU identifier (ID) and a TIADF. The TIADF includes an FESP trust index threshold. The WTRU receives an FESP discovery response including a list of FESPs. Each FESP of the list of FESPs is associated with an FESP trust index value greater than the FESP trust index threshold. The WTRU selects an FESP from the list of FESPs.

In an embodiment, on a condition that the FESP discovery response includes a TMFID, the WTRU identifies a TMF associated with the TMF ID. The WTRU transmits a request to the TMF to determine an FESC trust index value.

In an embodiment, the FESC trust index value is greater than an FESC trust index threshold.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a system diagram illustrating an example fifth generation (5G) security system according to an embodiment;

FIG. 3 is a system diagram illustrating an example dynamic service access system according to an embodiment;

FIG. 4 is an architecture diagram illustrating an example architecture of a trust index aware repository function (TIARF) according to an embodiment;

FIG. 5 is a flow diagram illustrating an example process of a trust index aware registration of a function entity service producer (FESP) according to an embodiment;

FIG. 6 is a flow diagram illustrating an example process of a trust index aware FESP discovery according to an embodiment;

FIG. 7 is a flow diagram illustrating an example process of a trust index triggered FESP deregistration according to an embodiment;

FIG. 8 is an architecture diagram illustrating an example architecture of a permissioned distributed ledger (PDL) based TIARF according to an embodiment;

FIG. 9 is a flowchart illustrating an example process for a trust index aware FESP registration according to an embodiment; and

FIG. 10 is a flowchart illustrating an example process for a trust index aware FESP discovery according to an embodiment.

### DETAILED DESCRIPTION

As discussed herein, one or more abbreviations in the following (non-exhaustive) list, shown in Table 1, may be used herein.

TABLE 1

| | |
|---|---|
| 3GPP | 3rd Generation Partnership Project |
| 5G | 5th Generation |
| 5GC | 5G Core Network |
| 5GS | 5G System |
| 6G | 6th Generation |
| 6GC | 6G Core Network |
| 6GS | 6G System |
| ADDR | Address |
| AF | Application Function |
| AMF | Access and Mobility Management Function |
| AS | Access Stratum |
| AUSF | Authentication Server Function |
| DN | Data Network |
| DUID | Decentralized User Identifier |
| DVUC | Distributedly Verifiable User Credential |
| ETSI | European Telecommunications Standards Institute |
| FESC | Function Entity Service Consumer |
| FESP | Function Entity Service Producer |
| GPSI | Generic Public Subscription Identifier |
| GR | Group Report |
| GS | Group Specification |
| GUTI | Globally Unique Temporary Identity |
| ID | Identifier |
| ISG | Industry Specification Group |
| LMF | Location Management Function |
| ME | Mobile Equipment |
| NAS | Non-Access Stratum |
| NEF | Network Exposure Function |
| NF | Network Function |
| NRF | Network Repository Function |
| NWDAF | Network Data Analytics Function |
| PCF | Policy Control Function |
| PDU | Protocol Data Unit |
| PDL | Permissioned Distributed Ledger |
| PLMN | Public Land Mobile Network |
| SA | Service Architecture |
| SBA | Service-Based Architecture |
| SEAF | Security Anchor Function |
| SIDF | Subscription Identifier De-concealing Function |
| SSI | Self-Sovereign Identity |
| SUCI | Subscription Concealed Identifier |
| SUPI | Subscription Permanent Identifier |
| TIARF | Trust Index Aware Repository Function |
| UDM | Unified Data Management |
| UDR | Unified Data Repository |
| UDSF | Unstructured Data Storage Function |
| UE | User Equipment |
| USIM | Universal Subscriber Identity Module |

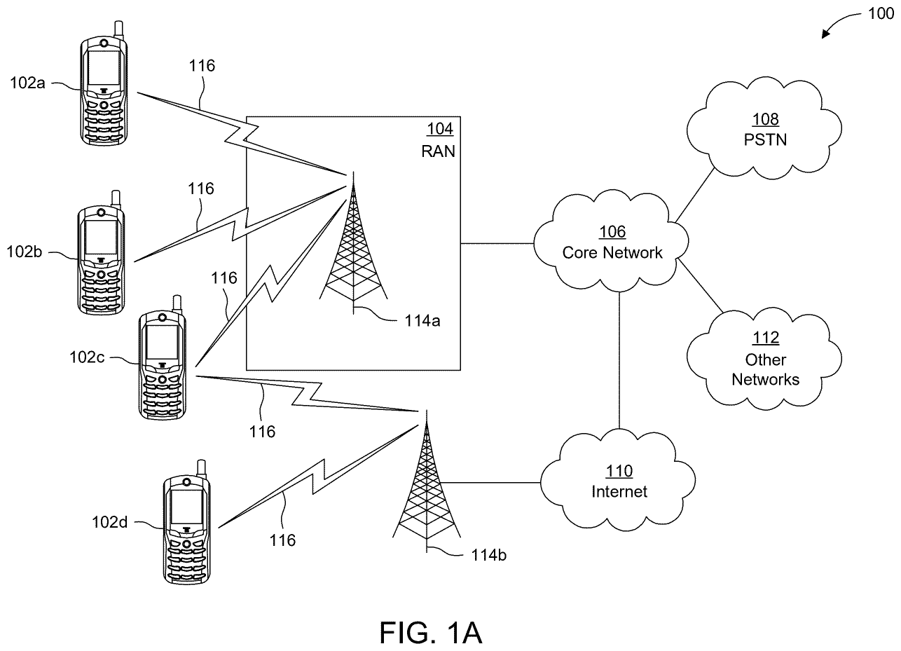

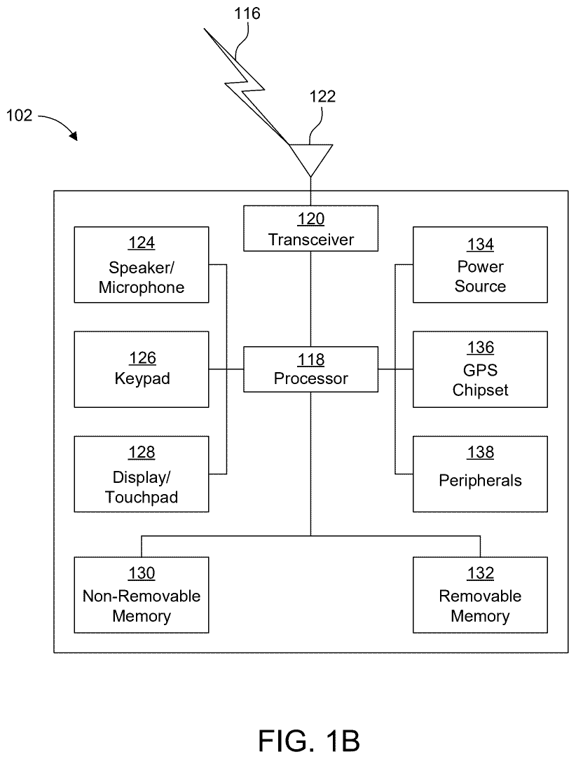

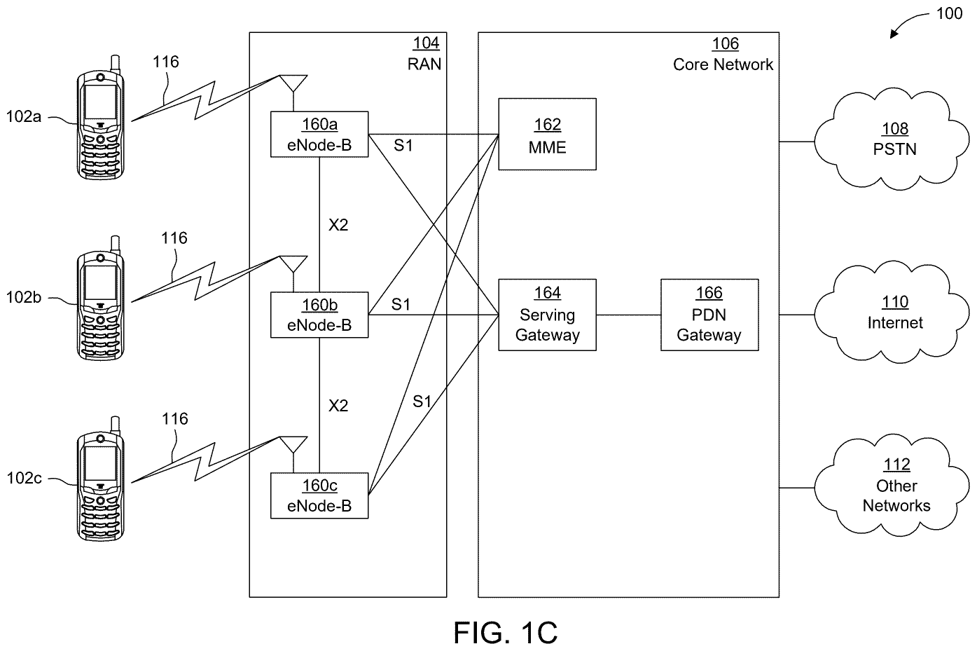

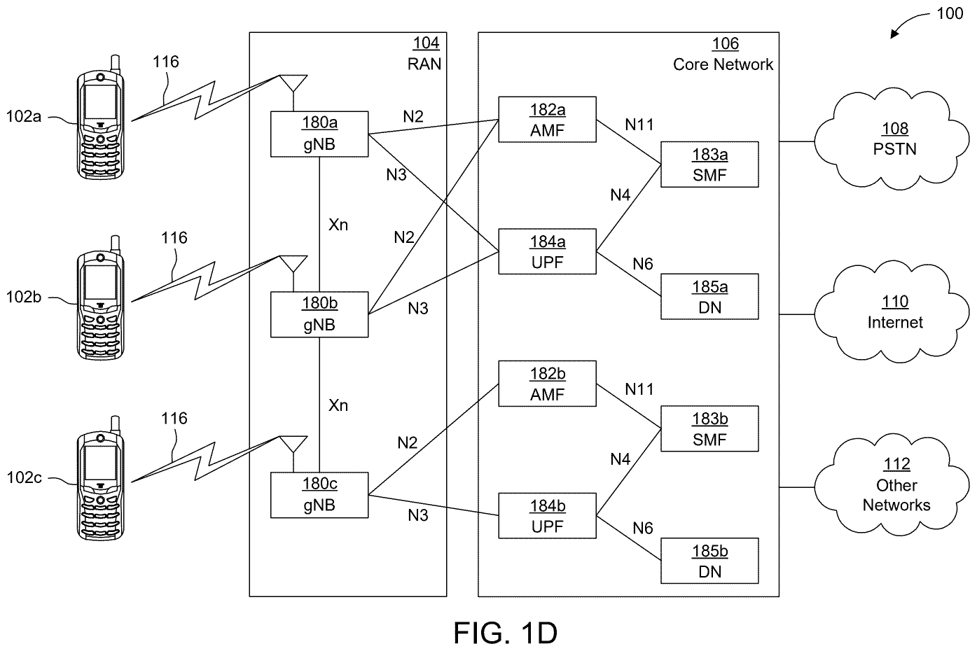

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth© module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a,184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

In fifth generation (5G) systems (5GS), a network repository function (NRF) provides a set of services to enable authentication and/or authorization between a NF service consumer and a NF service producer, such as but not limited to registration service and/or discovery service etc., for example. However, these services are unaware of a consumer trust index of the NF service consumer and/or a provider trust index of the NF service producer. As a result, these services may not be useful. For example, the NF service consumer may discover a few NF service producers with mismatched trust indexes.

Further, the 5GS do not consider user authentication based on a user trust index and/or a user context, both of which dynamically vary based on multiple factors such as but not limited to time, location, devices used for accessing the 5GS, multiple users using same devices for accessing the 5GS, public and/or private networks used for accessing the 5GS, etc., for example. That is, the 5GS does not consider dynamic user context and does not well support dynamic user authentication. A primary authentication in the 5GS is based on statically configured information (i.e., a root key), which cannot reflect and/or capture the dynamically changing user context and/or user trust index. A static authorization in the 5GS is only based on local authorization policies, which cannot reflect and/or capture the dynamically changing user context and/or the user trust index. In token-based authorization in the 5GS, an access token cannot reflect and/or capture the dynamically changing user context and/or the user trust index. The 5GS do not support dynamic user authentication based on the user trust index. Further, existing solutions about user identifier and/or user authentication do not reflect and/or support the user trust index. Therefore, 5GS may be vulnerable to security threats.

To address one or more of the above issues, the present disclosure provides a trust index aware repository function (TIARF) system architecture, which provides a mutual trust between a “discovering” function entity service consumer (FESC) and a “discovered” function entity service provider (FESP). The TIARF uses an FESP trust index of the FESP, an FESC trust index of the FESC and one or more requirements of the FESP and/or the FESC. The one or more requirements may be associated with one or more trust indexes of the FESP and/or the FESC to discover one or more appropriate FESPs to provide services for the FESC and/or to expose the FESP to one or more appropriate FESCs. The TIARF may reside in a core network (CN). Additionally, the TIARF may reside on a user equipment (UE) (e.g. a wireless transmit/receive unit (WTRU) and/or a mobile equipment (ME) and a universal subscriber identity module (USIM)), a radio access network, a service enabler server, an edge processing server, an application function (AF), and/or a server in a data network. The FESC and/or the FESP may be a UE (i.e. a WTRU) used by a user to access and/or provide one or more services. In an embodiment, the TIARF system architecture provides a trust index aware FESP registration process. In an embodiment, the TIARF system architecture provides a trust index aware FESP discovery process. In an embodiment, the TIARF system architecture provides a trust index triggered FESP deregistration process.

Typically, a 5G system architecture includes the UE (i.e. the WTRU), a radio access network (RAN), and the CN as specified in 3GPP TS 23.501. One of various design principles for the 5GS is service-centric and/or service-based designs. A 5G core network (5GC) implements a service-based architecture (SBA) and includes a variety of Network Functions (NFs), which work together to fulfill and/or provide the one or more services to the RAN, the UEs (i.e. the WTRUs), and/or application servers and/or service providers etc., for example. The WTRU interacts with the RAN and/or 5GC via non-access stratum (NAS) and/or access stratum (AS) signaling. An NF may access other network functions in request and/or response modes and/or subscription and/or notification modes. Before two NFs interact with each other, the two NFs first need to register with a network repository function (NRF) so that the two NFs may discover each other via the NRF. Among these NFs, an access and mobility management function (AMF) manages accesses and mobility of the WTRU in the 5GS, a session management function (SMF) establishes various sessions between the WTRU and the 5GC, and an authentication server function (AUSF) authenticates the WTRU. In addition, a policy control function (PCF) provides various policy rules for one or more control plane network functions and/or the WTRUs. The PCF assigns an identifier for each created policy rule, which other control plane network functions and/or the WTRUs use to refer to the corresponding policy rule. A user plane function (UPF) is a core network function in a data plane that facilitates monitoring, managing, controlling, and/or redirecting user plane traffic flows such as between the WTRU and the AF. A network exposure function (NEF) enables access to one or more 5G control plane functions to entities such as but not limited to various network applications and/or the AFs which are outside of the 5GS and not in same trusted domain.

The two NFs (a first NF as a service consumer and a second NF other as a service producer) may communicate with each other directly without any entity as an intermediary or may communicate indirectly via a service communication proxy (SCP). The SCP forwards and/or routes messages between an NF service consumer and an NF service producer. The two NFs may also interact with each other using a request and/or response model and/or subscribe and/or notify model. In the request and/or response model, the NF service consumer transmits a request to the NF service producer. The NF service producer processes the request and transmits a response to the NF service consumer. In the subscribe and/or notify model, the NF service consumer first transmits a subscription request to the NF service producer. The NF service producer processes the subscription request and stores the subscription information. Whenever any subscribed event occurs, the NF service producer transmits a notification to the NF service consumer.

The 5GC also provides data storage and analytics services through functions such as but not limited to unified data management (UDM), unified data repository (UDR), unstructured data storage function (UDSF) and/or network data analytics function (NWDAF) etc., for example. Another critical feature of the 5GS is network slicing, which is facilitated by network slice selection function (NSSF). The 5GS introduces a few network functions such as but not limited to a location management function (LMF) to support location services. The LMF calculates, determines, and/or verifies a final location and any velocity estimation and may estimate an achieved accuracy, based on location information from a target WTRU and/or a RAN node. After the LMF calculates the location of the target WTRU, other entities may access and/or query the location from the LMF but may need to go through a serving AMF.

Although these network functions are described as separate logical entities, a particular service scenario may require multiple network functions. For instance, a WTRU mobility may need not only the AMF, but also the AUSF and/or the SMF. For one or more types of NFs, multiple NF instances may be instantiated and the NRF may maintain information of each instantiated NF instance. With the emergence of edge computing, some network functions in the 5GC such as the UPF and/or the NEF may be deployed and/or resided in an edge network that is much nearer to and/or potentially co-located with the RAN.

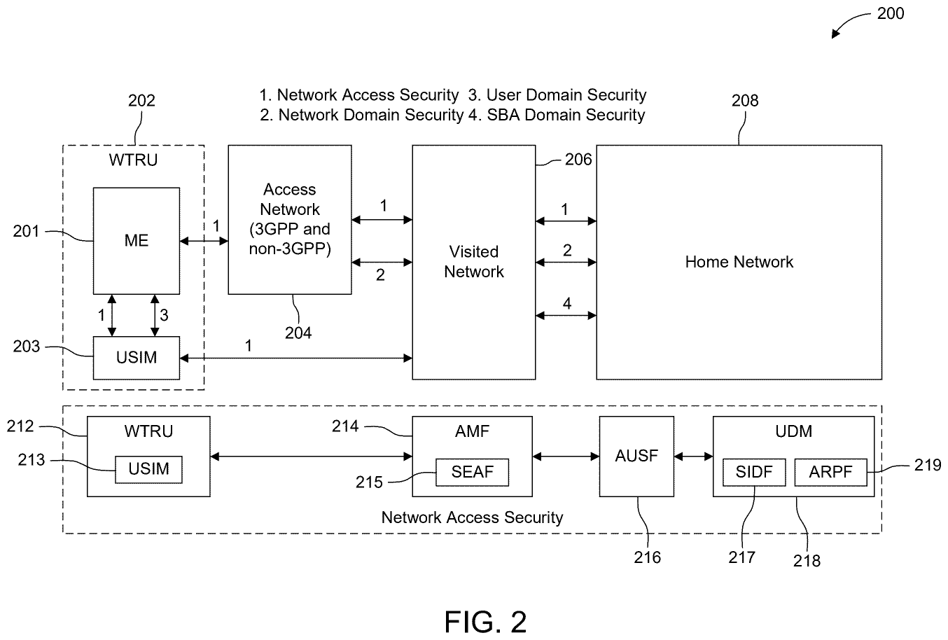

FIG. 2 is a system diagram illustrating an example 5G security system 200 according to an embodiment. The 5G security system 200 includes a WTRU 202, an access network 204, a visited network 206, and a home network 208. The WTRU 202 includes an ME 201 and a USIM 203. The 5G security system 200 further includes a WTRU 212, an AMF 214, an AUSF 216, and a UDM 218. The WTRU 212 includes a USIM 213. The AMF 214 includes an SEAF 215. The UDM 218 includes an SIDF 217 and an ARPF 219.

As illustrated in FIG. 2, the 5G security functions include four different security domains within the 5G system, viz, (1) security for network access between the WTRU and the RAN and/or 5GC, (2) a network domain security between the RAN and the 5GC, (3) a user domain security between the ME and the USIM, and (4) an SBA domain security in the 5GC.

The 5G network access security is realized mainly through network access authentication, message encryption, and/or message integrity protection etc., for example. The network access authentication includes primary authentication and key agreement and secondary authentication.

The primary authentication and key agreement are designed to enable: (1) a mutual authentication between the WTRU and the network, and (2) agreed keying material (e.g., an anchor key K_{SEAF}) at both, a network side and a WTRU side. A basis behind the 5G primary authentication and key agreement is that the same long-term key K (unique to the WTRU) is securely maintained at the USIM and the network, based on which the anchor key K_{SEAF} and the other key materials (e.g., keys for encryption and/or integrity protection for the NAS and/or AS signaling) may independently and/or identically be derived at the WTRU and at the network, without exchanging over the air. The mutual authentication is established when the WTRU and the network prove to each other that they know the same long-term key K. Since the primary authentication is solely based on the long-term key K, it does not consider user-centric aspects (e.g., user behavior etc.) and cannot authenticate and/or differentiate users from same and/or different WTRUs.

The secondary authentication is designed as an option to provide security between the WTRU and an external data network (DN) as a part of a session management. The secondary authentication relies on the SMF to initiate and coordinate the authentication procedure between the WTRU and the DN (e.g., an authentication, authorization, and accounting server e.g. a DN-AAA server).

In an example, a blockchain system may be (1) a permissionless blockchain system (e.g., Bitcoin, Ethereum etc.) where any party and/or user may use and/or participate in the blockchain system without pre-granted permissions, or (2) a permissioned blockchain system where an access to the blockchain system may be permissioned, controlled and/or governed. A permissioned distributed ledger (PDL) as described by ETSI industry specification group (ISG) on PDL is an example of permissioned blockchain systems.

In an example, the ETSI ISG on PDL publishes group reports (GRs) and group specifications (GSs) on various topics such as PDL reference architecture, use cases, specific PDL functionalities, and vertical domains. The ETSI GR PDL-021 describes use cases where the PDL may be leveraged and integrated with the 3GPP system such as the 5GS. The ETSI GS PDL-024 develops standards for provisioning one or more PDL services within the 3GPP system. In an example, three functions are described in the ETSI GS PLD-024, viz, a distributed ledger anchor function (DLAF), a distributed ledger repository function (DLRF), and a distributed ledger enabler (DLE). The DLAF and the DLRF are introduced as two control plane functions for the 3GPP system, while the DLE may be a data plane function. The ETSI GS PDL-027 aims to develop specify various technical requirements and/or solutions based on the PDL to build a native self-sovereign identity (SSI) system under one or more constraints of a telecom network so that the user and/or a network node holding such an identity may access network services among different operators and/or service providers seamlessly.

In an embodiment, a security system of the present disclosure provides trust evaluation and/or management. Here, the trust may refer to a measurable belief that represents an accumulated value (e.g. about quality, behavior, performance, and/or characteristic etc. of the network node, the WTRU, the service and/or or any logical, physical, and/or other entities etc.) from history and/or an expected value for future. The trust may be objective trust and/or subjective trust. The objective trust leverages a security mechanism, such as authentication, to validate an identity of any entity. However, the trust covers concerns beyond security. For example, an entity passing the authentication procedure only means the entity has successfully proved its identity, it still may not be fully trusted since the trust about the behavior and/or characteristics of the entity may still change dynamically. A criteria for evaluating trust may also be subjective, e.g. based on a personal experience, and/or a preference of the user. The trust is an essential input for decision making and is usually measured and/or calculated based on history, experience and/or records of past actions. The trust is a value that represents the expected value of the quality, behavior, characteristics, and/or performance in the future.

A trust index is a value that may be obtained via a trust evaluation process. The trust index may be used to describe the trust of the entity. The trust index is an overall metric, which may be calculated and/or determined based on the aggregation of one or more trust indicators (depending on the user's subjective trust evaluation criteria) using certain trust evaluation, calculation, and/or algorithms etc., for example. The trust indicators may cover various aspects, such as but not limited to security, privacy, resilience, performance, robustness, scalability, availability, accuracy, reliability, and/or consistency, etc. During a trust evaluation process, various data about an entity may be collected and the data may be used as inputs to calculate various trust indicators, which in turn are aggregated into an overall metric, i.e. a current trust index of the entity. Trust may have various characteristics. For example, the trust is dynamic, meaning that a given trust index may be applicable for a limited time period and may change as time goes on. The trust is also context-dependent, which means that the trust may have a significant change if the context is changed. The trust is not transitive in nature, but the trust may be transitive in some particular contexts. Similarly, the trust is an asymmetric relationship, meaning that a fact of an entity A trusting an entity B cannot deduce that the entity B also trusts the entity A. In addition, the trust may also be subjective, which means for the same entity, different users may have different criteria, opinions, and/or preferences regarding how to evaluate the trust of this entity and what kinds of trust-related aspects and/or indicators may be considered, etc.

In an example, existing cellular wireless systems (e.g., the 5GS) provide various security functions as described in 3GPP TS 33.501 such as primary authentication during registration, secondary authentication during a protocol data unit (PDU) session establishment, a NF service authorization, a network slicing-specific authentication and/or authorization, a network slicing admission control, a data plane encryption and/or an integrity protection, etc.

The NF service authorization in the 5GS may be static authorization and/or token-based authorization. In the static authorization, one or more local authorization policies may be maintained at the NRF and the NF service producer. The one or more local authorization policies may be used to authorize the NF service consumer, when the NF service consumer discovers the NF service producers from the NRF or when the NF service consumer requests to access services from a discovered NF service producer. In the token-based authorization, the NRF may grant an access token to the NF service consumer. Then, the NF service consumer presents the access token to the NF service producer, which may authorize the NF service consumer based on the access token.

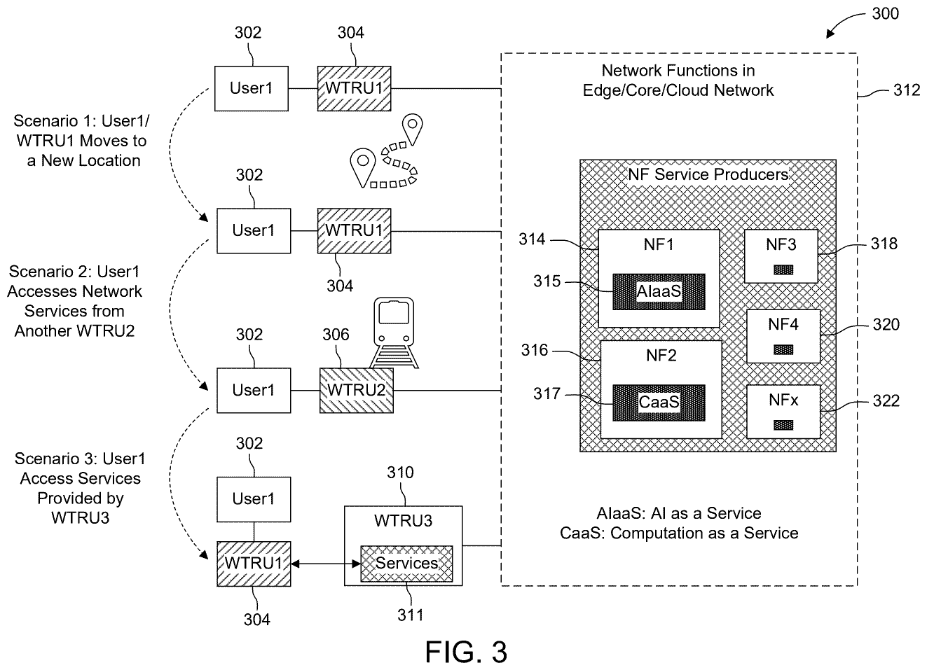

FIG. 3 is a system diagram illustrating an example dynamic service access system 300 according to an embodiment. The dynamic service access system 300 illustrates multiple behaviors and/or use cases of a user 302 using a first WTRU 304 to access a plurality of NFs 312 residing in an edge processing server, a core network, and/or a cloud network etc., for example. The NFs 312 may be provided by multiple NF service producers including first through x-th NF service producers NF-1 to NF-x. The user 302 may also access the NFs 312 through a second WTRU 306 and/or a third WTRU 310.

In an embodiment, the user 302 may access multiple services provided by the network (e.g. the NFs 312) and/or multiple services provided by the third WTRU 310 with highly dynamic behavior. Examples of services may include but are not limited to the NWDAF, an AI as a Service (AIaaS) 315, a Computation as a Service (CaaS) 317, a Sensing as a Service, etc. The dynamic behavior may be for the user 302 to access the services from a new location, to access the services via different devices (e.g. via the second WTRU 306 and/or the third WTRU 310 etc.) and/or at different times, to switch to access different services provided by another device (e.g. the third WTRU 310 etc.) for a reduced latency and/or other improvement in performance and/or experience, etc., for example. The dynamic behavior may lead to changing trustworthiness among interacting and/or involved entities (e.g., the user 302, the first through third WTRUs 304, 306, and 310, and/or the NFs 312, and/or networks, etc.). For example, a previously established relationship between the user 302 and the NFs 312 may become not trustable anymore. In many examples, the user 302 may be a human user, the application on the device, the application within the network, the device behind another device, and/or any other logical entity as the service consumer etc.

FIG. 3 illustrates three scenarios of dynamic service access by the user 302 in one or more wireless networks such as but not limited to mobile networks (e.g. 3G, 4G, 5G and/or 6G etc.) and/or other networks such as but not limited to WiFi, LiFi, Wi-Max etc., for example.

In an example, in a first scenario, the user 302 currently uses the first WTRU 304. The user 302 and/or the first WTRU 304 moves to a new location (e.g., a train station) and continues to access services from a new network (e.g., the AIaaS 315 provided by the NF1 314). Here, moving to a public area with more potential security attacks may lead to a change in the trust (e.g. the trust index value) of the user 302 and/or the first WTRU 304.

In an example, in a second scenario, a train has a mounted device (i.e., the second WTRU 306), which provides better wireless connectivity and overall performance to the user 302 while the training is moving. The user 302 gets on the train and changes to associate with and/or use the second WTRU 306 to access the network services (e.g., the CaaS 317 provided by the NF2 316). For example, the second WTRU 306 may provide a WiFi-based hotspot service within the train. Each seat may have a built-in WiFi terminal. As a result, the user 302 uses the built-in WiFi terminal to connect to the second WTRU 306 and eventually get to access network services. Alternatively, the user 302 may still use the first WTRU 304 to connect to the second WTRU 306 (via WiFi and/or sidelink etc., for example), and then get to access network services.

In an example, in a third scenario, while using the AIaaS 315 from the NF1 314, the user 302 and/or the first WTRU 304 arrives at a shopping mall and gets off the train. It turns out that the third WTRU 310 (e.g., a device and/or a WTRU at a store) in the proximity of the first WTRU 304 also provides needed the AIaaS 315. The AIaaS 315 (e.g. the services 311) on the third WTRU 310 may provide store-customized AI model for shopping suggestions for free. The user 302 changes to access the AIaaS 315 (e.g. the services 311) from the third WTRU 310 and stops using the AIaaS 315 from the NF1 314.

In these dynamic service access scenarios, the context of the user 302 (e.g., the location of the user 302, the first WTRU 304 that the user 302 is associated with, and/or the location of services being accessed etc.) changes from time to time. As such, the trust index of the user 302 also changes accordingly. Thus, to authorize whether the user 302 is allowed to access the network services (e.g. the NFs 312) and/or the services 311 provided by the third WTRU 310 needs to be dynamically assessed and/or reassessed.

In the 5GS, the NRF provides multiple services to enable authentication and/or authorization between the NF service consumer and the NF service producer. For example, the registration service, discovery service, and/or access token services and other NRF services may be provided. However, the services are unaware of the trust indexes of the NF service consumers and/or the NF service producers. As a result, these services may not be useful in situations that require trustworthiness. For example, the NF service consumer may discover some of the NF service producers with mismatched trust indexes.

In conventional 5GS, a first issue is the NF service producer cannot indicate any requirements associated with the trust indexes of the NF service consumers that the NF service procedure discovers. As a result, the NF service consumer that discovers the NF service producer from the NRF may be rejected eventually by the NF service producer if the trust index of the NF service consumer is insufficient. Further, a second issue is the NF service producer that the NF service consumer discovers from the NRF may have a low trust index and does not meet the requirement of the NF service consumer.

In an embodiment, the device may be the WTRU as described in 3GPP TR 21.905. The device may also be a non-WTRU, which connects to the WTRU via a non-cellular link to access a cellular network. The device may have one or multiple on-device applications.

In an example, the user may be any entity (such as but not limited to a human user, but not necessarily a human user) that uses the device. The user may be outside of the device or an entity within the device. The NF consumer may be the user. The FESC may be the user. The application running on the WTRU may be regarded as a user too. The WTRU (especially a WTRU without USIM) may also be regarded as the user. The device that uses the WTRU to access the 3GPP network may also be the user of the WTRU.

In an embodiment, a function entity (FE) may be a processing function such as but not limited to the NFs as described in 3GPP TS 23.501. The FE in this disclosure may also be the AFs, one or more edge applications and/or services, the services provided by the device, the applications provided at the device, the servers and/or services in the data network, etc., for example. The FESC may be the FE that accesses services provided by the FESPs (e.g., the NF service producers as described in 3GPP TS 23.501). The FESC may be the NF service consumers as described in 3GPP TS 23.501. In an example, the device (e.g. the UE and/or the WTRU) may be the FESC. A single device may have multiple FESCs. The FESP may be the FE that provides services to the FESCs. The FESP may be the NF service producer as described in 3GPP TS 23.501, the AF, the edge application service, the service enabler, the function at radio access network, the function at local area network, and/or the services on other devices etc., for example. The device may be the FESP. The single device may have multiple FESPs.

In an example, the trust index may be a metric to show, represent, and/or reflect the trustworthiness (e.g. a level of trustworthiness) of the logical entity and/or the physical entity (e.g., the device, the user, and/or the FE etc.). The trust index may be an absolute floating number or an integer. In this case, the higher the trust index of the entity is, the more trustworthy the entity is. The trust index also may be categorical data to indicate multiple levels of trust (e.g., “very low trust”, “low trust”, “medium trust”, “high trust”, and/or “every high trust”, etc.). As a result, a trust index threshold may be a number and/or a trust level. The trust index may be calculated during a long or a short period of time and thus the trust index may be an instantaneous trust index or an average trust index. The trust index of an entity may be a reputation value of the entity and/or may be based on a reputation value of the entity.

In an example, a device trust index (DTI) may be the trust index of the device. A user trust index (UTI) may be the trust index of the user.

In an embodiment, a trust management function (TMF) may be the FE that assesses, determines and/or calculates the trust index of the entity (e.g., the device, the user, the FE, the AF, the NF, the service, and/or the application, etc.). The TMF may also expose the calculated trust index to other FEs. The TMF may assess and calculate the trust index of the FESCs and/or the FESPs.

In an embodiment, a trust index aware repository function (TIARF) may be a repository function which is aware of the trust indexes of both the FESCs and/or the FESPs and in turn provides the mutual trust between the FESC (i.e. the entity that is discovering) and the FESP (i.e. the entity that is discovered) based on the respective trust indexes. The TIARF may reside in the CN. Additionally, the TIARF may reside on the WTRU, as the service enabler server, on the edge application server, on radio access network, as the AF, and/or as the server in the data network.

In an embodiment, an identifier may be the name, identifier, and/or address of an entity (e.g., the user, the device, the FE, and/or the entity using the device, etc.). The identifier may be the 3GPP identifier, an internet protocol (IP) address, a URL (Uniform Resource Locator), a FQDN (Fully Qualified Domain Name), a blockchain address, and/or distributed user identifier, etc., for example. The identifier of the entity enables and/or provides access details based on which other entities may access and/or interact with the entity.

In an embodiment, a distributed user identifier (DUID) may be a special type of an identifier for the user that may be created and/or owned by the user without relying on a third party. The DUID may be independently formed and/or established by the user using a DUID generation algorithm and/or function, which may be based on some unique and/or private information of the user such as but not limited to a private key, user attributes or properties, and/or user biometrics etc., for example. Any entity (e.g., the device, the application on the device, the FE, the service provided at the device, and/or the NF etc.) may create and/or possess the DUID as well.

In an embodiment, a distributed verifiable user credential (DVUC) may be a credential created and/or issued for the user. The DVUC may be verified and/or authenticated in a distributed way without contacting the party that creates the DVUC. The user may have one or more DVUCs. When an unauthorized user needs to access services from the entity such as the NF, the user may present the DVUC to the entity to get the DVUC authenticated and eventually establish a trust relationship with the entity offering the services. A new DVUC may deprecate an existing DVUC. The new DVUC may be dependent on one or more existing DVUC.

In many embodiments, various techniques for trust-based authentication may consider the user trust and/or the device trust for the service consumer and/or the trust index of the service producer, which have various design principles and benefits. The design principles include that a system architecture may be: (1) flexible and applicable for different use cases (e.g., scenarios in FIG. 3), (2) applicable to different NF service interaction modes (e.g., the request and response mode, the subscribe and notify mode, and/or indirect service interaction via the SCP etc.), (3) avoid introducing high communication or computation overhead to devices, (4) compatible with the architecture of the 3GPP system, and/or (5) allow for integration with 3GPP procedures. The benefits of the techniques include: (1) the system that is a more user-aware wireless system by incorporating the user trust index, the device trust index, a service consumer trust index and/or a service producer trust index into the user authentication, and/or (2) the system that supports more secure service interaction via trust-based authentication considering dynamically changing user trust index. In many examples, existing services provided by the NRF include but are not limited to the service producer registration, the service producer discovery, and the access token generation. In an example, the NRFs and/or the services are not trust index aware. The techniques of the present disclosure that use the trust awareness brings multiple benefits such as but not limited to: (1) the FESC can discover trustable FESPs, (2) prevents an un-trustable and/or low-trust FESC to discover the FESPs, and/or (3) matches the FESCs and/or FESPs in terms of expectation on each other's trust indexes.

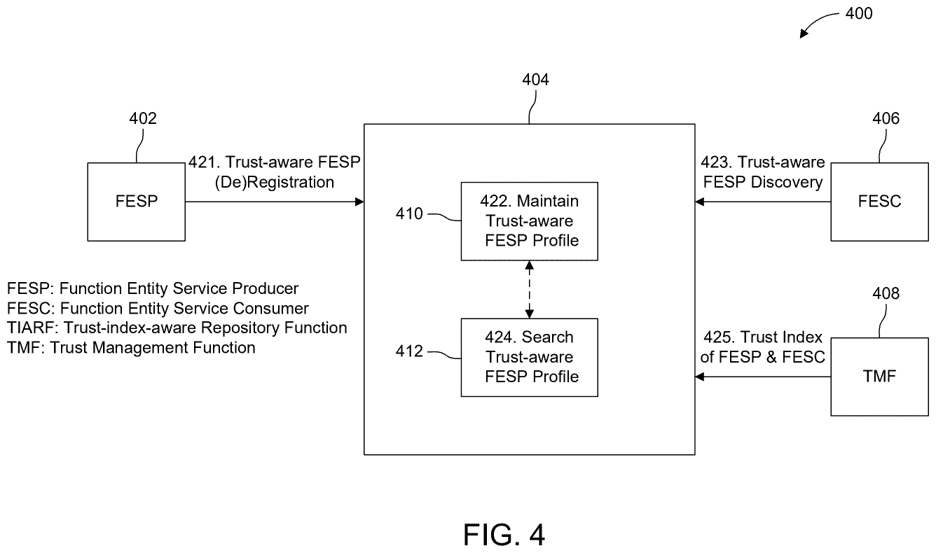

FIG. 4 is an architecture diagram illustrating an example architecture 400 of a TIARF 404 according to an embodiment. The architecture 400 includes an FESP 402, the TIARF 404, an FESC 406, and a TMF 408. The TIARF 404 may include a registration function 410 for maintaining a trust aware FESP profile registration and a search function 412 for searching the trust aware FESP profiles.

The TIARF 404 provides mutual trust between the FESC 406 (that is discovering a service) and the discovered FESP 402 (providing the service). Essentially, the TIARF 404 uses the trust indexes of the FESPs and the FESCs (including the FESP 402 and the FESC 406) and the requirements on each other's trust to find the appropriate FESPs to provide service for the FESC 406 and/or expose the FESP 402 to more appropriate FESCs. As an example of exposing the FESP 402 to FESCs, the TIARF 404 may maintain a list of existing FESCs that have attempted to discover the FESPs and are willing to be maintained by the TIARF 404, and actively select one or more new FESPs that match the requirements of the FESCs associated with the trust indexes of the FESPs, and push and/or transmit the identifiers of one or more selected FESPs to the FESCs that match the requirements of the FESPs associated with the trust indexes of the FESCs. The TIARF 404 may reside in the CN. Additionally, the TIARF 404 may reside on the WTRU, on radio access network, as the service enabler server, on the edge application server, as the AF, or as the server in the data network. The FESC may be the user and/or the WTRU.

In many embodiments, the TIARF 404 may provide various interactions, as shown in FIG. 4, between the FESPs, the FESCs, and/or TMFs. At 421 and 422 shown in FIG. 4, the FESP 402 registers itself with the TIARF 404 by providing an FESP profile to the TIARF 404. The FESP profile may include the trust index related information and the requirements on the trust index of FESCs that may discover the FESP 402. In other words, the trust index related information may include a set of information to be used for enabling trust index aware registration, and may include but is not limited to (1) the trust index related information about FESP 402 itself (such as a trust index value, a valid time window, how to obtain the trust index value, etc.), and (2) one or more trust index related requirements for one or more potential FESCs, which describe and/or identify the FESCs that are eligible to discover the FESP 402 and/or use services provided by the FESP 402. The TIARF 404 receives and/or maintains multiple trust aware FESP profiles associated with multiple FESPs. The TIARF 404 and/or the FESP 402 may trigger to de-register a previously registered FESP.

At 423 and 424 shown in FIG. 4, the FESC 406 discovers the FESPs by sending a request and receiving a response from the TIARF 404. The FESC 406 may indicate the requirements associated with the trust index of any FESPs that the FESC 406 discovers. The TIARF 404 may search the maintained trust aware FESP profiles to select the one or more FESPs matching the request of the FESC 406, especially considering the requirements on the trust (considering mutual trust between the FESP 402 and the FESC 406) and send the matched FESPs to the FESC 406. The TIARF 404 may store the identifier or the address of the FESC 406, through which the TIARF 404 may send notifications (e.g., new FESPs) to the FESC 406 in future. The TIARF 404 may consult the TMF 408 to obtain one or more updated trust indexes of the FESCs and/or the FESPs. Here, consulting the TMF 408 may mean transmitting a request to the TMF 408 (so that TMF 408 may calculate a latest trust index associated with the FESP 402 and/or the FESC 406) and receiving a trust index value from the TMF 408.

At 425 shown in FIG. 4, the TIARF 404 may receive updates on the trust index of the FESPs and/or the FESCs, based on which the TIARF 404 may remove and/or cancel the FESP registrations of the FESPs. When the TIARF 404 determines that the trust index of the FESP 402 has changed, the TIARF 404 may transmit a notification to the FESC 406 to notify the FESC 406 that the trust index of the FESP 402 has changed, assuming the TIARF 404 stores or maintains the FESC 406 (e.g., its identifier) when the FESC 405 is registered with the TIARF 404 at 423 and 424. For example, the TIARF 404 may notify the FESC 406 that the FESP 402 which the FESC 406 previously discovered is now less trustworthy than when the FESP 402 was discovered.

In an embodiment, the FESP 402 may register itself to the TIARF 404 by transmitting the FESP 402 profile to the TIARF 404. The FESP 402 profile may include the trust index related information such as but not limited to: (1) whether and how the trust index of the FESP 402 may be obtained. The examples may be the current trust index of the FESP 402, the valid time window of the trust index, the specific TMF instance that calculated the trust index of the FESP 402, and/or the application scope (e.g. the trust information may be applicable for which services provided by the FESP 402), etc., for example, (2) whether the FESP 402 has trust index requirements on the FESCs that may consume services provided by the FESP 402. The examples may be the minimum trust index threshold that the FESC 406 has to achieve in order to be eligible to discover the FESP 402, etc., and (3) whether the FESP 402 may employ the trust index to authenticate and/or authorize the FESC 406 (e.g. the FESP 402 may require that all the FESCs that may discover the FESP 402 must be authenticated and/or authorized based on the trust indexes). The TIARF 404 may store the FESP profiles and make the FESP profiles (entirely or partially) available to the FESCs to discover the FESPs.

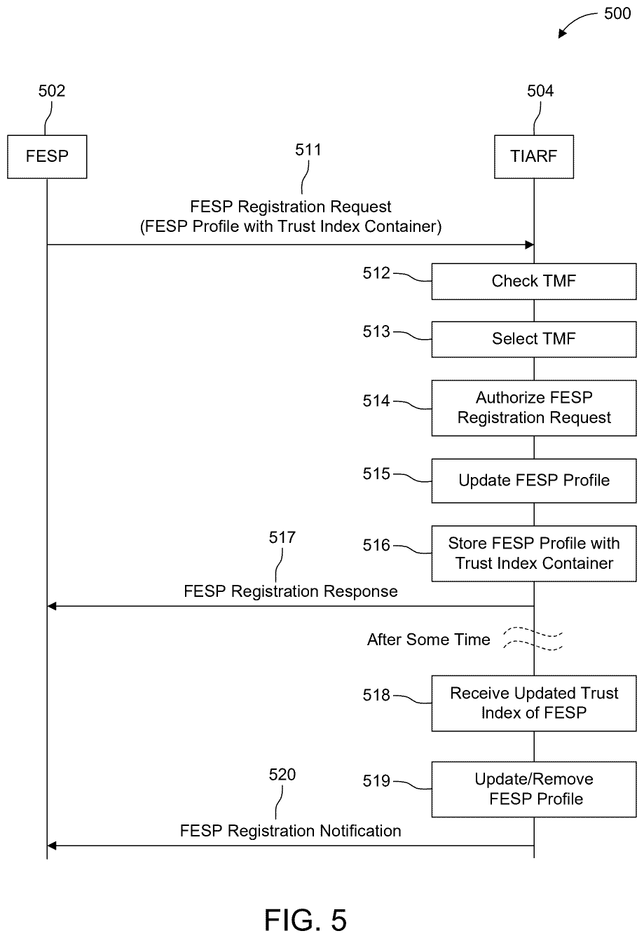

FIG. 5 is a flow diagram illustrating an example process 500 of a trust index aware registration of an FESP 502 according to an embodiment. The process 500 may be performed by and/or between the FESP 502 and a TIARF 504. FIG. 5 illustrates the process 500 of trust index aware FESP registration. In the process 500, the TIARF 504 may be replaced with the authorization server and/or another repository function. For example, devices in the wireless systems may provide services (e.g., sharing computing power, data, sensing, intelligence, and/or inference, etc.) as the FESP 502 to other devices or networks as the FESC. In this scenario, the wireless systems may have a digital twin service (DTS), which may maintain digital versions of the devices as the FESPs including a list of services provided by the devices. The DTS may transmit requests to the TMF to retrieve the latest trust indexes of the devices as the FESPs. As a result, the devices may discover the FESP-like devices from the DTS. In this setting, the DTS has the TIARF 504 functionality as described in FIG. 5. The FESP 502 hosts a set of services, which may be accessed by the FESCs. It may be assumed that the FESP 502 is provisioned and/or configured with the address of the TIARF 504.

At 511, the FESP 502 transmits an FESP registration request to the TIARF 504. This request may include various parameters and/or information elements, such as but not limited to an identifier of the FESP 502 (FESPID), a list of service types that the FESP 502 provides (ServiceType), a list of service names that the FESP 502 provides (ServiceName), a trust index container (TIC), a credential of the FESP 502 to authorize the FESP registration request (FESPCredential), and/or an address for receiving registration notifications (e.g., registration cancellation) that the TIARF 504 may asynchronously generate and/or send to the FESP (RegNotifAddr) etc., for example. All information included in 511 may be regarded as a FESP profile of the FESP 502.

The TIC may include trust index related information, which may be applied to one or more services that the FESP 502 supports and/or provides. In an example, the FESP 502 may have multiple TICs and each TIC may apply to a different service of the FESP 502. In other words, separate trust index related information may be provided for each service and used to determine a separate trust index for each of the one or more services of the FESP 502. Therefore, the FESP registration request may include multiple TICs. Each TIC may include various parameters and/or information elements related to the respective TIC. The TIC may include an identifier of the TIC (TICID), a type of services that the TIC applies to (ServiceType), and/or names of services that the TIC applies to (ServiceName).

The TIC may further include an indication (TIAuthFESPSupport) of whether the FESP 502 supports authentication and/or authorization by the FESCs based on the trust index of the FESP 502 (i.e. the FESP trust index). For example, if TIAuthFESPSupport=TRUE (or 1), the FESP 502 supports the trust index-based authentication and/or authorization by FESCs (i.e., the FESP 502 supports to be authenticated by FESCs using trust index based authentication and/or authorization).

The TIC may further include an indication (FESPTIValue) of the FESP trust index associated with the FESP 502. The FESPTIValue may be indicative of an instantaneous trust index value, and/or an average trust index value calculated over a period of time as denoted by FESPTIWindow. The FESPTIValue may be signed by the TMF and/or by any other entity which has calculated, determined and/or generated the FESPTIVaIue.

The TIC may further include an indication (FESPTIThresholdForBeingDiscoverable) associated with a trust index threshold for the FESP 502. When the FESP trust index of the FESP 502 is above the trust index threshold, the FESP 502 may be discovered by the FESCs. The FESPTIThresholdForBeingDiscoverable may be associated with the average trust index calculated over the period of time as denoted by the FESPTIWindow and/or may be associated with the instantaneous trust index value. FESPTIThresholdForBeingDiscoverable may be determined and/or configured by the TIARF 504 for the FESP 502 after the FESP 502 is successfully registered with the TIARF 504.

The TIC may include a period of time (i.e. the FESPTIWindow) over which the trust index of the FESP 502 should be calculated.

The TIC may include an identifier of the TMF (i.e. the TMFID) which may calculate and expose the trust index of the FESP 502. If the TMFID is not included in the TIC, the TIARF 504 may select other and/or suitable TMF for the FESP 502.

The TIC may include an indication (TIAuthFESCRequire) of whether the FESP 502 supports and/or requires that FESCs must be authenticated and/or authorized based on the respective trust indexes. For example, if the TIAuthFESCRequire=TRUE (or 1), the FESP 502 requires to perform the trust index-based authentication on the FESCs.

The TIC may include an indication (FESCTIThresholdForDiscoverable) associated with an FESC trust index threshold for the FESCs. The FESP 502 may only be discovered by the FESCs whose trust index is higher than the FESC trust index threshold. The FESCTIThresholdForDiscoverable may be associated with the average trust index calculated over the period of time as denoted by the FESCTIWindow and/or may be associated with the instantaneous trust index.

The TIC may include a period of time (i.e. the FESCTIWindow) over which the trust index of the FESCs should be calculated and/or recalculated.

The TIC may include a trust index threshold (TIThresholdForKeepingReg). Only if the FESP trust index of the FESP 502 is not below (or above) the TIThresholdForKeepingReg, the TIARF 504 may maintain the FESP as registered including the respective FESP profile. Otherwise, the TIARF 504 may delete the FESP profile and/or remove the registration (i.e. deregister) of the FESP 502. TIThresholdForKeepingReg may be determined and/or configured by the TIARF 504 for the FESP 502 after the FESP 502 is successfully registered with the TIARF 504.

At 512, after the TIARF 504 receives the FESP registration request, if the TMFID is included in the FESP registration request, the TIARF 504 may contact the TMF as indicated by the TMFID for one or multiple purposes. The TIARF 504 may check with the TMF if the FESP 502 is allowed to use the TMF to calculate the FESP trust index associated with the FESP 502 and/or if the TMF agrees to calculate the FESP trust index of the FESP 502. The TMF may transmit a response to the TIARF 504 indicating if the TMF may calculate and/or expose the trust index of the FESP 502.

In that, to retrieve the instantaneous trust index and/or the average trust index of the FESP 502, the TMF may transmit a response to the TIARF 504 indicating the instantaneous and/or the average trust index of the FESP 502. The TIARF 504 may replace the FESPTIValue as received in 511 with the retrieved FESP trust index (e.g. the instantaneous trust index and/or the average trust index of the FESP 502) of the FESP 502. The TMF may only send a categorial trust index of the FESP 502 to the TIARF 504 although the TMF may have calculated the trust index of the FESP 502 in an absolute floating number and/or an integer.

At 513, if the TMFID is not included in the FESP registration request, the TIARF 504 may select a TMF from a local list of TMFs (assuming the TMFs are registered with the TIARF 504 and/or the TIARF 504 is provisioned with one or multiple TMFs). The TMF may have indicated to the TIARF 504 the list of service names and/or the list of service types and/or the list of FESP identifiers that the TMF may calculate the trust indexes for. As a result, the TIARF 504 may select an appropriate TMF matching the FESP 502 including the service names and/or the service types. Even if the TMFID is included in the FESP registration request, the TIARF 504 may reselect the TMF for the FESP 502. If the TMF is selected and/or reselected, the TIARF 504 may transmit the request to the selected TMF to check and/or confirm whether the selected TMF is able to and/or agrees to calculate the FESP trust index associated with the FESP 502.

At 514, the TIARF 504 may authorize the FESP registration request using one or more methods of authorization. In an example, the TIARF 504 may conduct validation based on the FESPCredential to authorize the FESP registration request. For example, the TIARF 504 may validate the FESPCredential to decide whether the FESP 502 is allowed for the FESP registration. In an example, the TIARF 504 may authorize the FESP registration request based on the FESPTIVaIue. For example, if the FESPTIVaIue is greater than a pre-configured value (e.g. an FESP trust index threshold), the TIARF 504 may approve, allow, and/or permit the FESP registration request. The TIARF 504 may authorize the FESP registration request by inquiring the TMF (as indicated by the TMFID) about the latest trust index of the FESP 502. For example, the TIARF 504 may contact the TMF as indicated by the TMFID to retrieve the average and/or a most recent trust index of the FESP 502; as a result, the TMF may send the average and/or a most recent trust index of the FESP 502 to the TIARF 504. If the retrieved trust index of the FESP 502 is above the pre-configured value (e.g. the FESP trust index threshold), the TIARF 504 may approve, allow, and/or permit the FESP registration request. If the TIARF 504 does not approve, allow, and/or permit the FESP registration request, 515-516 may be skipped.

At 515, the TIARF 504 may update the FESP profile. For example, the TIARF 504 may update the parameters of the TIC included in the FESP profile. For example, if the TMF is selected and/or reselected in 513, the TIARF 504 may include an updated TMFID and/or a new TMFID in the TIC as received in 511. The previous TMFID in the TIC may be replaced with the updated TMFID and/or the new TMFID of the new TMF selected in 513. In 513, the selected TMF may indicate a new FESPTIWindow to the TIARF 504. The TIARF 504 may replace the previous FESPTIWindow in the TIC with the new FESPTIWindow. The TIARF 540 may introduce and/or add one or more new parameters to the TIC. In an example, the TIARF 504 may update and/or determine TIThresholdForKeepingReg, FESPTIThresholdForBeingDiscoverable, and/or FESCTIThresholdForDiscoverable for the FESP 502.

In an example, the TIARF 504 may add an FESPDiscoverable parameter. The FESPDiscoverable may be set to TRUE to indicate that the FESP 502 is discoverable. For example, if the trust index of the FESP 502 is large enough, the TIARF 504 may set the FESPDiscoverable to TRUE and let the FESP 502 be discoverable. Otherwise, the TIARF 504 may set the FESPDiscoverable to FALSE but may change it later from FALSE to TRUE when the trust index of the FESP 502 exceeds one or more trust index thresholds or vice versa.

At 516, in an example, the TIARF 504 may store the updated FESP profile. Each stored FESP profile may have an identifier. Each stored FESP may include the information received from 511 and/or updated parameters of TIC in 515.

At 517, the TIARF 504 may generate and transmit an FESP registration response to the FESP 502. The FESP registration response may include and/or indicate various information elements and/or parameters. The FESP registration response may indicate whether the FESP registration request has been approved, allowed, and/or permitted in 514. The FESP registration response may include the identifier of the stored FESP profile. The FESP registration response may include the address (TrustIndexNotifAddr) for the TIARF 504 to receive updates on the trust index of the FESP 502. Examples of the address may include but are not limited to an end-point, an identifier, a fully qualified domain name (FQDN), an application programming interface (API), and/or a uniform resource locator (URL) etc. The FESP registration response may include the updated TIC determined and/or generated in 515. If the updated TIC includes the new TMF, the FESP 502 may transmit a request with the TrustIndexNotifAddr to the TMF to trigger the TMF to calculate its trust index once and/or repeatedly. The FESP 502 may also request the TMF to calculate the trust index and transmit each calculated trust index to the TIARF 504. Whenever a new trust index is calculated, the TMF may transmit the new trust index to the TrustIndexNotifAddr, which may be received by the TIARF 504.

At 518, at any time after 517, the TIARF 504 may receive the updated trust index of the FESP 502 from the TMF (e.g., the TMF indicated in 511 and/or selected in 513) and/or from the FESP 502 itself.

At 519, based on the updated trust index of the FESP 502 from 518, the TIARF 504 may update and/or even remove the FESP profile stored in 516.

First, the TIARF 504 may replace the trust index included in the FESP profile (i.e., the FESPTIValue) with the new trust index value received in 518.

In an example, if the updated trust index is below the trust index threshold, the TIARF 504 may set the FESPDiscoverable=FALSE or 0 indicating that the FESP 502 cannot be discovered by FESCs. If the FESP 502 has been already discovered by some of the FESCs, the TIARF 504 may transmit one or more notifications to the FESCs indicating that the FESP 502 is marked as less trustable. Then, the FESCs may remove the FESP 502 from respective lists of discovered FESPs stored by the FESCs.

In another example, if the updated trust index is above the trust index threshold, the TIARF 504 may reset the FESPDiscoverable=TRUE or 1 indicating that the FESP 502 may be discovered again by the FESCs. The TIARF 504 may transmit the one or more notifications to the FESCs indicating that the FESP 502 is marked as more trustable and/or discoverable.

In another example, if the updated trust index is extremely low (e.g., smaller than the preconfigured trust index threshold and/or the TIThresholdForKeepingReg as indicated in 511), the TIARF 504 may delete the FESP profile and/or cancel the previous registration of the FESP 502 as set up via 511-517. The TIARF 504 may transmit the one or more notifications to the FESCs indicating that the FESP 502 is marked as less trustable and/or non-discoverable and is de-registered.

At 520, if the FESP profile was updated in 519, the TIARF 504 may transmit the FESP registration notification to an impacted FESP 502 using the RegNotifAddr received in 511. The FESP registration notification may include the updated parameters of the FESP profile in 519. If the FESP profile was removed in 519, the FESP registration notification may indicate to the impacted FESP 502 that the registration of the FESP 502 has been cancelled and it no longer presents in the TIARF 504.

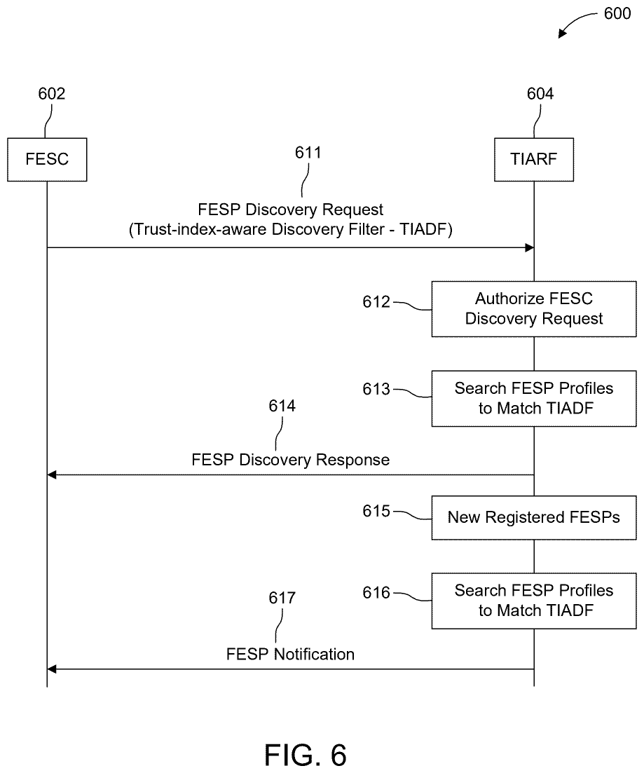

FIG. 6 is a flow diagram illustrating an example process 600 of a trust index aware FESP discovery according to an embodiment. The process 600 may be implemented by and/or between an FESC 602 and a TIARF 604. At 611, the FESC 602 transmits an FESP discovery request to the TIARF 604. The FESP discovery request may include the identifier of the FESC 602 and a trust index aware discovery filter (TIADF). The FESP discovery request may include the credential of the FESC 602. The FESP discovery request may include a timer (FESPNotifTimer) that allows the TIARF 604 to transmit the FESP notifications (e.g., in 617) to the FESC 602 before the timer expires; this timer may be determined by the TIARF in 613 and be sent to the FESC 602 in 614; multiple such timers may be included in 611 and one such timer for a different service type or service name that the FESC 602 requests to discover.

The TIADF may include one or more parameters and/or information elements. The TIADF may include a list of service types (ExpectedServiceType) requested and/or needed by the FESC 602. The TIADF may include a list of service names (ExpectedServiceName) requested and/or needed by the FESC 602. The TIADF may include the TIC provided by the FESC 602. In that, the TIADF may include an indication of the trust index (FESCTIValue) of the FESC 602. The FESCTIValue may be the instantaneous trust index and/or the average trust index calculated more recently over the period of time. The FESCTIValue may be signed by the TMF and/or any other entity which has calculated the FESCTIValue. The TIADF may include an indication (TIAuthFESPReq) of whether the FESC 602 requires the target FESPs be authenticated and/or authorized by the FESC 602 based on the trust indexes of the target FESPs. For example, if the TIAuthFESPReq=TRUE (or 1), the FESC 602 aims to discover the FESPs that may be authenticated and/or authorized by the FESC 602 using trust indexes of the target FESPs.

The TIADF may further include an indication (TIAuthFESCSupport) of whether the FESC 602 supports to be authenticated and/or authorized by FESPs based on the trust index of the FESC 602. For example, if the TIAuthFESCSupport=TRUE (or 1), the FESC 602 supports trust index-based authentication by the FESPs.

The TIADF may include an indication (FESPTIThresholdForDiscovering) of a trust index threshold for the target FESPs. The FESPTIThresholdForDiscovering indicates that the FESC 602 aims to only discover the target FESPs whose trust index is greater than the FESPTIThreshold.

The TIADF may include the identifier (the TMFID) of the TMF which may calculate and/or expose the trust index of the FESC 602. If the TMFID was not included in 611, the TIARF 604 may select the TMF for the FESC 602 during 612 and/or 613.

At 612, the TIARF 604 receives the FESP discovery request and may authorize the FESP discovery request using one or multiple following methods.

The TIARF 604 may authorize the FESP discovery request based on the FESCTIValue. For example, if the FESCTIValue is greater than the pre-configured trust index threshold, the TIARF 604 may approve, allow, and/or permit the FESP discovery request.

The TIARF 604 may authorize the FESP discovery request by inquiring the TMF (as indicated by the TMFID) about the latest trust of the FESC 602. For example, the TIARF 604 may contact the TMF as indicated by the TMFID to retrieve the average trust index and/or the most recent trust index (i.e. the instantaneous trust index) of the FESC 602; as a result, the TMF may send the latest trust index of the FESC 602 to the TIARF 604. If the retrieved trust index of the FESC 602 is above the pre-configured trust index threshold, the TIARF 604 may approve, allow, and/or permit the FESP discovery request.

The TIARF 604 may authorize the FESP discovery request using the credential of the FESC 602 assuming the TIARF 604 has the credential and/or receive it from 611.

At 613, the TIARF 604 searches the FESP profiles (stored as a result of the FESP registrations) against the TIADF to match the FESP profiles and the TIADF with each other. The TIARF 604 marks each FESP with a matching FESP profile as a discovered target FESP. Through this process, the TIARF 604 may find multiple target FESPs. An example of a matching FESP profile with the TIADF is as follows: First, the TIARF 604 finds a preliminary list of FESPs with the following matches. In an example, the ExpectedServiceType in the TIADF may match the ServiceType in the FESP profile and/or the ExpectedServiceName in the TIADF may match the ServiceName in the FESP profile. In another example, the TIAuthFESPReq in the TIADF may match with the TIAuthFESPSupport in the FESP profile. In another example, the TIAuthFESCSupport in the TIADF may match with the TIAuthFESCRequire in the FESP profile, and/or the FESCTIValue in the TIADF may be above the FESCTIThresholdForDiscoverable in the FESP profile. Second, for each preliminary FESP, the TIARF 604 may check if the trust index of the FESP is the latest or not. If not, the TIARF 604 may retrieve the latest trust index from the TMF as included in the FESP profile. Then, the TIARF 604 may continue to check one or more conditions and/or generate the final list of discovered FESPs. In one example condition, the trust index of the FESP may be required to be above the FESPTIThresholdForDiscovering as included in the TIADF. Each FESP in the final list meets the one or more conditions as described above. Dependent on the trust index of the FESC 602, the TIARF 604 may limit the number of the FESPs to be discovered and/or notified to the FESC 602. For example, the TIARF 604 may discover and/or return and/or notify more FESPs to the FESC 602 with a higher trust index. In addition, the TIARF 604 may choose the FESPs that have the same TMFID of the FESC 602 as the target FESPs.

At 614, the TIARF 604 generates and transmits the FESP discovery response to the FESC 602. The FESP discovery response may include the final list of the target FESPs as discovered in 613 (e.g., the identifiers and/or the profiles of the target FESPs). The FESP discovery response may include the TMFID, i.e. the identifier of the TMF selected in 613. After receiving the FESP discovery response and/or if this FESP discovery response includes the TMFID, the FESC 602 may transmit a request to the TMF (as denoted by the TMFID) to trigger the TMF to calculate the trust index of the FESC 602.

At 615, some new FESPs are registered with the TIARF 604. The newly registered FESPs and the FESC 602 may match with each other.

At 616, if the FESPNotifTimer of the FESC 602 has not expired, the TIARF 604 repeats 613 to determine if the FESC 602 and any of these new FESPs match with each other. In this, the TIARF 604 may re-retrieve the trust index of the FESC 602.

At 617, the TIARF 604 generates and transmits the FESP notification to the FESC 602. The FESP notification may include the information about any matching newly registered FESPs as determined in 616 (e.g., the FESP notification may include the identifier and/or the profiles of matching FESPs). In an example, 617 and 614 may include the same list of parameters.

In an example, a generalization may be that the process 600 may also be used for creating a network slice. For example, in 611, the FESC 602 may transmit a request to the TIARF 604 to identify a number of different types of FESPs, which may be various NFs for constituting a specific network slice. Accordingly, the TIARF 604 may conduct a trust index aware FESP discovery for each needed NF type and return a discovery result to the FESC 602; in this case, the discovery result may include multiple target FESPs as required by the requested network slice.

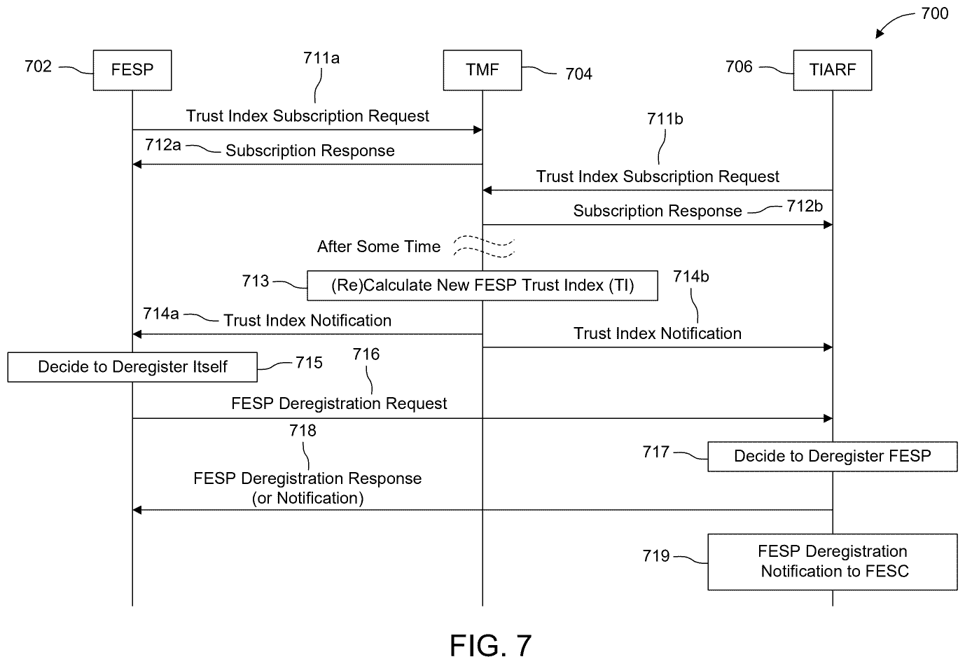

FIG. 7 is a flow diagram illustrating an example process 700 of a trust index-triggered FESP deregistration according to an embodiment. The process 700 may be performed by and/or between an FESP 702, a TMF 704, and a TIARF 706. The FESP 702 may be a registered FESP 702 with the TIARF 706. The trust index of the registered FESP 702 may change. When the trust index of the registered FESP 702 is below a threshold (e.g. within a trust index range, outside of a trust index range, and/or meeting other conditions), the registered FESP 702 may be de-registered, which may be triggered by the TIARF 706 and/or the registered FESP 702. An example trust index-triggered FESP deregistration is illustrated in FIG. 7.

At 711, the FESP 702 (at 711a) and/or the TIARF 706 (at 711b) may transmit a subscription request to the TMF 704 for receiving automatic notifications about the trust index of the FESP 702 (e.g. the FESPTI) when the trust index of the FESP 702 meets one or more FESP trust index conditions (e.g. the FESPTIConditions). The subscription request may include one or more parameters and/or information elements. In an example, the subscription request may include an identifier of the FESP (e.g. the FESPID). The subscription request may include one or more FESP trust index conditions (FESPTIConditions) based on which the TMF 704 may generate and transmit one or more trust index notifications to the FESP 702 and/or the TIARF 706. The FESP trust index conditions may include but are not limited to the FESPTI is below a threshold, the FESPTI is above a threshold, the FESPTI is within a range, and/or the FESPTI is outside of a range. The subscription request may further include an identifier of the subscriber (e.g. the FESPID for 711a, the identifier of the TIARF 706 for 711b).

At 712, the TMF 704 generates and transmits a subscription response to the FESP 702 (at 712a) and/or the TIARF 706 (at 712b) indicative of whether the subscription request of 711 is successful or failed. If the subscription request is failed, 713-719 may be skipped.

At 713, the TMF 704 monitors and/or calculates the trust index of the FESP 702 constantly, periodically, and/or dynamically. A new FESPTI may be calculated and may be checked to match the FESPTIConditions as received in 711.

At 714, the TMF 704 generates a trust index notification, which may include the new FESPTI and the identifier of FESP. The trust index notification may be sent to the FESP 702 and/or the TIARF 706. In an example, at 711a, the subscription request may have requested and/or indicated that the trust index notification should be sent to both the FESP 702 and/or the TIARF 706. In this case, 711a may also include the identifier of the TIARF 706. Similarly, 711b may have requested and/or indicated that the trust index notification should be sent to both the TIARF 706 and the FESP 702. That is, either 711a or 711b or both may trigger execution of 714a and/or 714b.

At 715, the FESP 702 may decide to de-register itself from the TIARF 706, which may be triggered for different reasons. For instance, the FESP 702 may be deregistered if the FESPTI received at 714a is below the threshold. In another example, the FESP 702 may not want to be discovered by more FESCs and/or the FESP 702 may not stop providing services; as such, the FESP 702 may decide to de-register itself from the TIARF 706.

At 716, the FESP 702 transmits a FESP deregistration request to the TIARF 706. The FESP deregistration request may include the identifier of the FESP 702, the identifier of the previous registration (which may be previously assigned by the TIARF 706 to the FESP 702), the identifier of the FESP profile of the FESP 702 as stored at the TIARF 706, the new FESPTI received from 714a.

At 717, the TIARF 706 decides to deregister the FESP 702. On one hand, the TIARF 706 receives the deregistration request at 716 and may decide to deregister the FESP 702 as requested. On the other hand, even if the TIARF 706 does not receive the deregistration request at 716, the TIARF 706 may still decide to de-register the FESP 702 (e.g., based on the new FESPTI received at 714b or the TIARF 706 decides not to overload the FESP 702). For example, if the new FESPTI is below the threshold, the TIARF 706 may remove the FESP profile that was previously created during FESP registration. In another example, if the FESP 702 is discovered and/or used by too many FESCs, the TIARF 706 may decide to protect the FESP 702 by de-registering the FESP 702 so that the FESP 702 may not be discovered by additional FESCs.

At 718, the TIARF generates and transmits an FESP deregistration response to the FESP 702 indicating successful deregistration. If the TIARF 706 did not receive the deregistration request at 716, the TIARF 706 may transmit a FESP deregistration notification to the FESP 702. The FESP deregistration notification may include the identifier of the FESP 702, the identifier of the removed FESP profile, the identifier of previous FESP registration being de-registered, the new FESPTI as received in 714b, and/or the reason for deregistration (e.g., the trust Index below the threshold, too many FESCs discovering the FESP 702 etc.).

At 719, the TIARF 706 may transmit the same FESP deregistration notification (as in 718) to one or more other FESCs, which may have previously discovered the de-registered FESP 702.

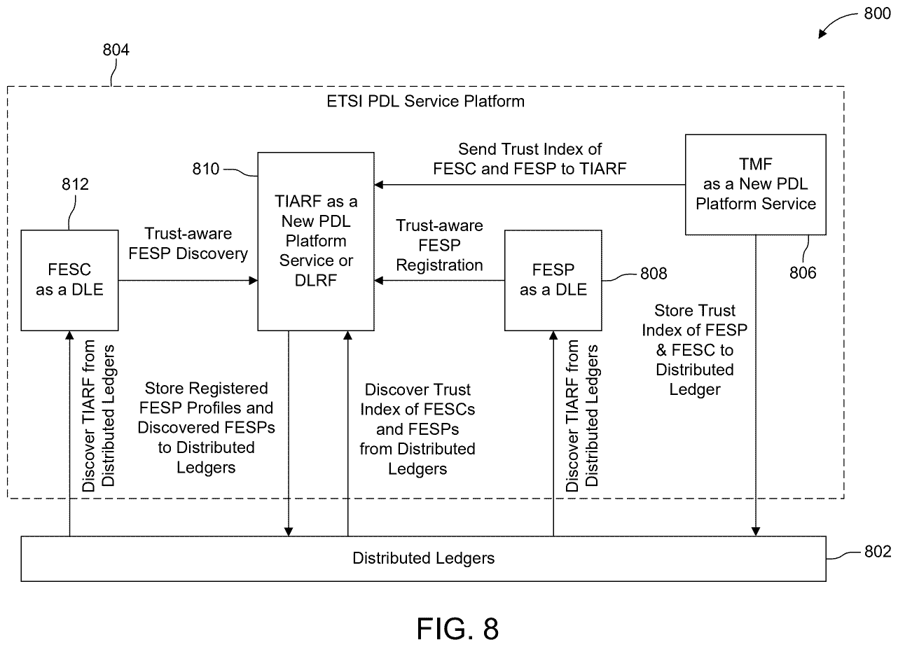

FIG. 8 is an architecture diagram illustrating an example architecture 800 of a PDL based TIARF according to an embodiment. The architecture 800 includes a plurality of distributed ledgers 802 and an ETSI PDL service platform 804. The ETSI PDL service platform 804 includes a TMF 806, an FESP 808, a TIARF 810, and an FESC 812.

In an example, following the PDL service architecture in ETSI GS PDL-024, in the architecture 800, the FESC 812 may be implemented as a distributed ledger enabler (DLE) node such as a DLE client. The FESC 812 may have an embedded DLE and/or may interact with an external DLE. The FESC 812 may rely on the DLE to interface to the PDL service platform 804.

In an example, the FESP 808 may be implemented as the DLE node such as a DLE peer. In an example, the FESC 812 may have an embedded DLE and/or interact with an external DLE. The FESP 808 may rely on the DLE to interface to the PDL service platform 804.

The TMF 806 may be implemented as a new PDL platform service, which may be accessed by the FESC 812 (as the DLE), the FESP 808 (as the DLE), and the TIARF 810 (as the new PDL platform service). The TMF 806 may record and/or store the calculated trust indexes of the FESCs and/or the FESPs including the TMF signatures to one or more distributed ledgers. In an example, the FESC 812 (or the FESP 808) may retrieve the respective trust index from the TMF 806 and then store the trust index in to the one or more distributed ledgers. In an example, the FESC 812 (or the FESP 808) may retrieve the respective trust index from the one or more distributed ledgers.

In an embodiment, the TIARF 810 may be implemented as a part of a distributed ledger repository function (DLRF) and/or a new PDL platform service. The PDL platform may have multiple and/or distributed TIARFs, which may coordinate with each other via the one or more distributed ledgers. The TIARF 810 may retrieve the trust indexes of the FESC 812 (or the FESP 808) from the TMF 806 or from one or more distributed ledgers.

The FESP 808 may first discover the TIARF 810 from the PDL service platform. Then, the FESP 808 registers itself to the TIARF 810. After the FESP 808 successfully registered with the TIARF 810, the TIARF 810 and/or FESP 808 may record each registered FESP 808 including the corresponding FESP profile to one or more distributed ledgers.

When the FESC 812 needs to discover the FESP 808, the FESC 812 may first discover the TIARF 810 from the PDL service platform. Then, the FESC 812 discovers the FESPs from a discovered TIARF. After the FESC 812 discovers one or more FESPs, the TIARF 810 and/or FESC 812 may also record each discovered FESP of the one or more FESPs and related information to the one or more distributed ledgers.

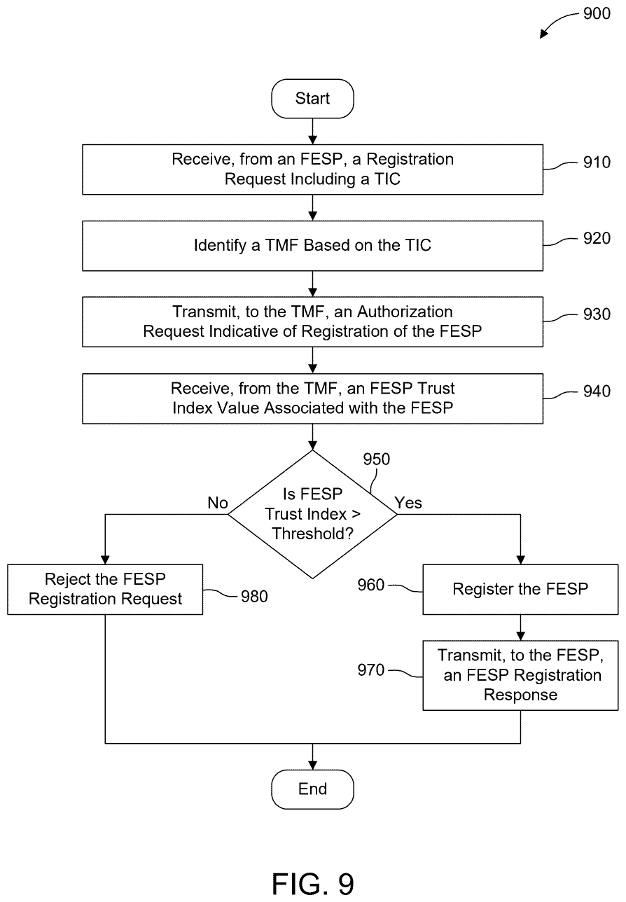

FIG. 9 is a flowchart illustrating an example process 900 for trust index aware FESP registration according to an embodiment. The process 900 may be performed by the TIARF.

At 910, the TIARF receives the registration request from the FESP. The registration request may include one or more TICs.

At 920, the TIARF checks whether any TIC of the one or more TICs includes a TMFID. If any TIC includes the TMFID, the TIARF selects the indicated TMF. If the one or more TICs do not include the TMFID, the TIARF determines at least one of the service type or the service name indicated in any TIC of the one or more TICs. The TIARF determines a list of TMFs. The TIARF selects, from the list of TMFs, the TMF associated with at least one of the service type or the service name.

At 930, the TIARF generates and transmits an authorization request to the TMF. The request may be indicative of checking whether the FESP may be registered. The authorization request may identify the FESP by way of one or more identifiers.

At 940, the TIARF receives the FESP trust index value from the TMF in response to the authorization request. The FESP trust index value may be the average trust index value associated with the FESP over the trust index window and/or the instantaneous trust index value (e.g. dynamic trust index value i.e. one or more dynamically changing trust index values) associated with the FESP.

At 950, the TIARF compares the FESP trust index value with a first trust index threshold. If the FESP trust index value is greater than the first trust index threshold, the TIARF may allow the registration of the FESP. If the FESP trust index value is not greater than the first trust index threshold, the TIARF may not allow the registration of the FESP.

At 960, if the TIARF determines that the FESP trust index value is greater than the first trust index threshold, the TIARF may register the FESP. In that, the TIARF may create and/or update, and store the FESP profile associated with the FESP. The TIARF may mark the FESP as discoverable if the FESP trust index value is greater than a second trust index threshold, which may or may not be equal to the first trust index threshold.

At 970, the TIARF may generate and transmit, to the FESP, the FESP registration response. The FESP registration response may include the created and/or updated FESP profile.

At 980, if the TIARF determines that the FESP trust index value is not greater than the first trust index threshold, the TIARF may reject the FESP registration request. The TIARF may mark the FESP as non-discoverable if the FESP trust index value is not greater than the second trust index threshold

In an example, the process 900 and/or the TIARF may be implemented by the WTRU. The process 900 and/or the TIARF may also be implemented in the CN. The process 900 and/or the TIARF may also be implemented by the enhanced NRF in the CN. The process 900 and/or the method may be implemented by a server in a data network. The process 900 and/or the method may be implemented at an edge network. The process 900 and/or the method may be implemented at a radio access network.

In an example, the TIARF receives an updated trust index value associated with the FESP. The updated trust index value may be generated and/or provided by the TMF (and/or by a different TMF). The TIARF may compare the updated the trust index value to a third trust index threshold. The TIARF may deregister the FESP if the updated trust index value is less than the third trust index threshold. The TIARF may delete the FESP profile associated with the FESP upon deregistering the FESP. In an example, the third trust index threshold and the first trust index threshold may be same and/or different. In an example, the third trust index threshold and the first trust index threshold may be in a same range, in different ranges, and/or in overlapping and/or partially overlapping ranges etc.

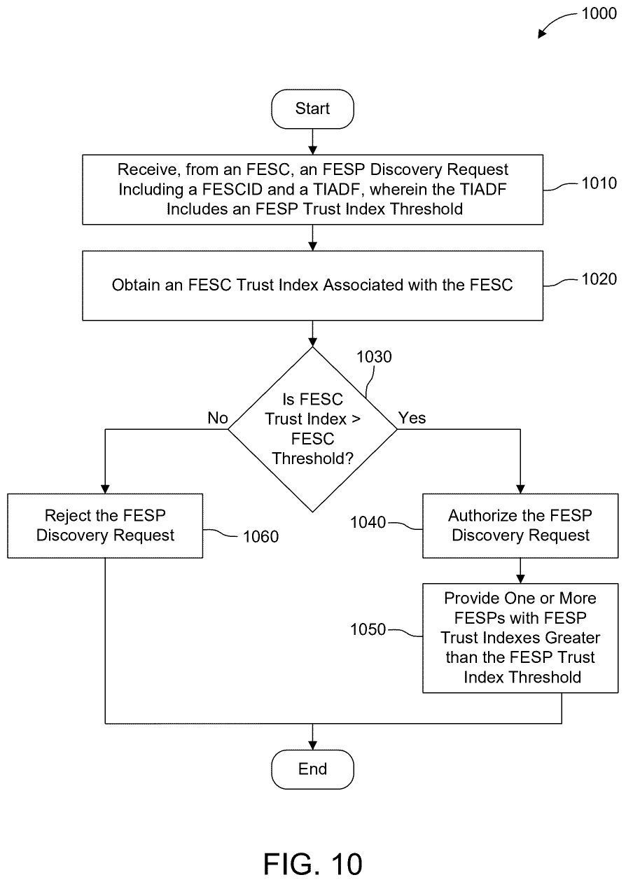

FIG. 10 is a flowchart illustrating an example process 1000 for a trust index aware FESP discovery according to an embodiment. The process 1000 may be performed by the TIARF.

At 1010, the TIARF receives the FESP discovery request from the FESC. The FESP discovery request may include the FESC ID and the TIADF. The TIADF may include an FESP trust index threshold.

At 1020, the TIARF obtains (e.g. queries the TMF) the FESC trust index associated with the FESC based on the FESC ID.

At 1030, the TIARF compares the FESC trust index with the FESC trust index threshold.

At 1040, the TIARF authorizes the FESP discovery request if the FESC trust index is greater than the FESC trust index threshold.

At 1050, the TIARF provides an FESP discovery response. The FESP discovery response includes information for identifying the one or more FESPs with the respective FESP trust indexes greater than the FESP trust index threshold indicted in the FESP discovery request.

At 1060, the TIARF rejects the FESP discovery request if the FESC trust index is not greater than the FESC trust index threshold.

Trust covers and is beyond security. The trust index may be obtained via a trust evaluation process (e.g. conducted by TMF). The trust index is an overall metric, which is often calculated based on the aggregation of one or more trust indicators using certain trust evaluation algorithms. For example, the trust indicators may cover various aspects, such as but not limited to security, privacy, resilience, performance, robustness, scalability, availability, accuracy, reliability, consistency, etc. More importantly, the criteria for evaluating trust may also be subjective, e.g. based on user, personal experience, and/or preference etc., for example. For example, given two entities A and B (who needs to interact with a third entity C), the entities A and B may have different criteria regarding how the trust of the entity C should be evaluated. For example, in case the entities A and B are service consumers and the entity C is a service producer, the entity A and the entity B may have different trust evaluation criteria regarding how to evaluate the trust of the entity C trust for providing various services. For example, the entity A may care more (e.g. prefer, select, and/or prioritize) about the security, privacy and/or resilience etc. (as one or more focused trust indicators) of the entity C when the entity C is providing the services to the entity A. In comparison, the entity B may care more (e.g. prefer, select, and/or prioritize) about a different set of trust indicators (such as availability and/or residency, etc., for example) of the entity C when the entity C is providing services to the entity B. Therefore, the present embodiments may have the following generalizations related to the trust index (it is to be noted that the following generalizations may be applicable to all the embodiments (e.g. methods, processes, apparatuses and/or systems etc.) in this disclosure, e.g. all the messaging between any entity and the TMF).

In a first generalization related to a trust index generation, when any requesting entity (e.g. the entity A, which may be but is not limited to the FESP, the FESC, etc. as described in this disclosure) needs to contact the TMF (e.g. sending a request to the TMF) to inquire the trust index of another target entity (e.g. the entity C) and/or to initiate trust evaluation on the target entity, the TMF not only may provide the trust index of the target entity (as described in this disclosure) and return the trust index to the requesting entity (e.g. the entity A), but also may return the associated explanatory information in the response, such as but not limited to one or more of: (1) When the trust index was generated. For example, the trust index may be generated by the TMF ten seconds ago, which reflects the latest trust index of the target entity; (2) How the trust index was generated. For example, this parameter may indicate a next level of information regarding what kinds of the trust evaluation criteria has been adopted by the TMF to generate the trust index. This parameter may indicate but is not limited to one or more of: (2.1) what kinds of data were collected for the trust evaluation and where the data were stored; (2.2) what kinds of trust indicators were focused; (2.3) what kinds of algorithms were adopted for calculating the trust indicators and/or the trust index; (2.4) During the trust evaluation, what kinds of collected data were used as inputs for the adopted algorithms in order to calculate the focused trust indicators and/or the overall trust index; (2.5) what kinds of parameter values were set during the calculation of the trust indicators and/or the overall trust index. It may be noted that the TMF may be pre-configured with a popular and/or standard suite of trust evaluation criteria, so that the TMF may conduct standard and/or popular trust evaluation, which may be appropriate and/or desired for most of requesting entities; (3) The applicable scope of the trust index. It is possible that a target entity (e.g. the entity C acting as the FESP) may provide different services, but the target entity may have different levels of trust when delivering those different services. For example, one service (e.g. Service X) provided by the target entity may be related to computing operations, while another service (e.g. Service Y) provided by the target entity may be related to communication operations. Therefore, it is possible that the target entity may have a high trust index for providing the Service-X, and at the same time, the FESP may have a low trust index for providing the Service Y. Overall, in the first generalization, anytime when the TMF needs to send the trust index to the receiver and/or the requester (i.e. the entity A, who has sent the request to the TMF for the trust index inquiry and/or the trust evaluation etc.), the above new information elements may also be attached, along with the returned trust index value.

A second generalization related to the trust index generation may include but is not limited to: when any requesting entity (such as the entity A) sends the request to the TMF to inquiry the trust index of the target entity (such as the entity C), the request may further include parameters which enable a customized trust evaluation by describing how the requesting entity (e.g., the entity A) prefers the TMF to conduct the trust evaluation on the target entity, or how trust index shall be calculated. For example, in addition to whose trust index is being inquired (e.g. the entity C), the following new information elements related to the customized trust evaluation criteria may also be included in the request sent from the entity A to the TMF: (1) How the trust of the target entity should be evaluated, e.g. what kinds of specific trust evaluation criteria should be adopted by the TMF to generate the trust index. This may include but is not limited to: what kinds of the trust indicators should be focused, what kinds of the algorithms should be adopted for calculating trust indicators and/or the trust index. Alternatively, the TMF may be pre-provisioned with different sets of the trust evaluation criteria (each may be identified by a trust evaluation criteria identifier). If that is the case, the entity A may directly indicate the trust evaluation criteria identifier of the preferred trust evaluation criteria when the entity A sends the trust index inquiry request to the TMF. By receiving this parameter, the TMF may adopt the corresponding trust evaluation criteria preferred by the entity A when the TMF conducts the trust evaluation on the target entity (i.e. the entity C) in order to generate the trust index of the target entity. (2) The applicable scope of the trust index. It is possible that the target entity (such as the entity C) may provide different services, but the target entity may have different levels of trust when delivering those different services. For example, one service (e.g. the Service X) provided by the target entity may be related to the computing operations, while another service (e.g. the Service Y) provided by the target entity may be related to communication operations. Therefore, this parameter is to indicate that the entity A intends to inquiry the trust index of the target entity (i.e. the entity C) regarding which the services. For example, the entity A may only want to know the trust of target entity for providing the specific Service X. Another example, the entity A may want to know the trust of target entity for providing a set of specific services (e.g. the Service X and/or the Service Y, etc.) or even all of the services provided by the target entity. Once the TMF receives this parameter, it allows the TMF to determine which data shall be collected in order to calculate the needed trust index. (3) The TMF may conduct the customized trust evaluation based on the above parameters sent from the entity A. One the trust index is generated by the TMF, the trust index may be returned to the entity A. Same as the first generalization related to trust index generation, when retuning the trust index to the entity A, the TMF not only may provide the trust index value of the target entity (e.g. a numerical value or a rank), but also may return a set of explanatory information, which may be the same as the parameters listed in the first generalization, such as but not limited to when the trust index was generated, how the trust index was generated (e.g. the adopted trust evaluation criteria, etc.), the applicable scope of the trust index, etc., for example.

In an example, one or more solutions (e.g. the techniques, methods, processes, functions, apparatuses, and/or systems etc.) proposed in this disclosure often involve with functions (e.g. steps in the methods and/or processes) related to that a requesting entity needs to interact with the TMF, such as “sending” a request to the TMF for inquiring the trust index of the target entity and “receiving” a response from the TMF, in which the inquired trust index is attached. It is proposed that such an interaction may be further generalized to “obtaining” the trust index of a target entity from the TMF. That is, depending on how the TMF is implemented, “obtaining” the trust index of the target entity may be realized in different ways. For example, the requesting entity may communicate with the TMF via intermediated medium (such as a distributed ledger). Also, the TMF may be implemented in different ways, e.g. the TMF may be implemented as a native 3GPP function, e.g. as a new NF in the CN, a new function inside an access network of a 3GPP system, and/or implemented as an enhanced feature of an existing NF in the 3GPP cellular system, such as but not limited to 5G network data analytics function (NWDAF) and/or a security function deployed by the MNO. In more examples, the TMF may also be implemented as a new ETSI PDL platform service, and/or the TMF may be implemented as a smart contract deployed in the distributed ledger system (in this case, the request and/or response may be embodied as one or more distributed ledger transactions, for example).

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random-access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A method for use in a trust index aware repository function (TIARF), the method comprising:
receiving, from a function entity service producer (FESP), a registration request including a trust index container (TIC);
identifying a trust management function (TMF) based on the TIC;
transmitting, to the TMF, an authorization request indicative of registration of the FESP;
receiving, from the TMF, a trust index value associated with the FESP;
comparing the trust index value to a first trust index threshold; and
transmitting, to the FESP, a registration response indicative of registration of the FESP if the trust index value is greater than the first trust index threshold.

2. The method of claim 1, wherein the method is implemented by one or more of:
a wireless transmit/receive unit (WTRU),
a function in a core network (CN),
a function in an edge network,
a function in a radio access network,
an enhanced network repository function (NRF) in the CN, or
a server in a data network.

3. The method of claim 1, wherein the trust index value is indicative of at least one of:
an instantaneous trust index value, or
an average trust index value averaged over a trust index window.

4. The method of claim 1, wherein the trust index value includes of at least one of:
a device trust index (DTI) value associated with the FESP, or
a user trust index (UTI) value associated with a user of the FESP.

5. The method of claim 1, wherein the trust index value associated with the FESP indicates a level of trustworthiness of the FESP.

6. The method of claim 5, wherein the trust index value is based on an evaluation of one or more trust indicators related to at least one of: security, privacy, resilience, performance, robustness, scalability, availability, accuracy, reputation, reliability, or consistency.

7. The method of claim 1, further comprising:
generating an updated FESP profile associated with the FESP based on the trust index value; and
storing the updated FESP profile, wherein the registration response includes the updated FESP profile.

8. The method of claim 7, wherein generating the updated FESP profile includes:
marking the FESP as discoverable if the trust index value is greater than a second trust index threshold; and
marking the FESP as non-discoverable if the trust index value is less than the second trust index threshold.

9. The method of claim 8, further comprising:
receiving, from the TMF, an updated trust index value associated with the FESP;
comparing updated the trust index value to a third trust index threshold;
de-registering the FESP if the updated trust index value is less than the third trust index threshold; and
deleting an FESP profile associated with the FESP upon deregistration of the FESP.

10. The method of claim 1, wherein selecting the TMF comprises:
on a condition that the TIC includes a TMF identifier (TMFID), identifying the TMF associated with the TMF ID; and
selecting the identified TMF.

11. The method of claim 10, wherein selecting the TMF further comprises:
on a condition that the TIC does not include the TMFID, determining at least one of a service type or a service name indicated by the TIC; and
selecting the TMF from a list of TMFs associated with at least one of the service type or the service name.

12. A device, comprising:
a memory;
a transceiver; and
a processor, wherein the transceiver and the processor are configured to:
receive, from a function entity service consumer (FESC), a function entity service producer (FESP) discovery request including a FESC identifier (ID) and a trust index aware discovery filter (TIADF), wherein the TIADF includes an FESP trust index threshold,
obtain an FESC trust index value associated with the FESC based on the FESC ID,
authorize the FESP discovery request if the FESC trust index value is greater than an FESC trust index threshold,
determine a list of FESPs wherein each FESP of the list of FESPs is associated with an FESP trust index value greater than the FESP trust index threshold, and
transmit, to the FESC, an FESP discovery response including the list of FESPs.

13. The device of claim 12, wherein the device is a wireless transmit/receive unit (WTRU) functioning as a trust index aware repository function (TIARF).

14. The device of claim 12, wherein the device is a server in a data network functioning as a trust index aware repository function (TIARF).

15. The device of claim 12, wherein the transceiver and the processor are further configured to:
transmit, to a trust management function (TMF), a request including the FESC ID, and
receive, from the TMF, the FESC trust index value associated with the FESC.

16. The device of claim 15, wherein the TIADF further includes a notification timer.

17. The device of claim 16, wherein the transceiver and the processor are further configured to:
receive, from the TMF, a first FESP trust index value associated with a first FESP, and
on a condition that the first FESP trust index value is greater than the FESP trust index threshold and the notification timer has not expired, transmit a notification indicative of the first FESP to the FESC.

18. A wireless transmit/receive unit (WTRU), comprising;
a memory;
a transceiver; and
a processor, wherein the transceiver and the processor are configured to:
transmit a function entity service producer (FESP) discovery request including a WTRU identifier (ID) and a trust index aware discovery filter (TIADF), wherein the TIADF includes an FESP trust index threshold,
receive an FESP discovery response including a list of FESPs, wherein each FESP of the list of FESPs is associated with an FESP trust index value greater than the FESP trust index threshold, and
select an FESP from the list of FESPs.

19. The WTRU of claim 18, wherein the transceiver and the processor are configured to:
on a condition that the FESP discovery response includes a trust management function (TMF) identifier (TMFID), identify a TMF associated with the TMF ID, and
transmit a request to the TMF to determine a function entity service consumer (FESC) trust index value.

20. The WTRU of claim 19, wherein the FESC trust index value is greater than an FESC trust index threshold.
